(19) United States
(12) Patent Application Publication
(10) Pub. No.: US 2008/0097688 A1
(43) Pub. Date: Apr. 24, 2008

(54) ROUTE GENERATION BASED UPON ACTIVITY CRITERIA

(75) Inventors: Ivan J. Tashev, Kirkland, WA (US); Jeffrey D. Couckuyt, Bothell, WA (US); Neil W. Black, Seattle, WA (US); John C. Krumm, Redmond, WA (US); Ruston Panabaker, Redmond, WA (US); Michael Lewis Seltzer, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/957,219

(22) Filed: Dec. 14, 2007

Related U.S. Application Data
(63) Continuation-in-part of application No. 11/426,903, filed on Jun. 27, 2006.

(51) Int. Cl. G01C 21/34

(52) U.S. Cl. 701/200

(57) ABSTRACT

A route can be optimized according to various constraints, specifically towards non-travel constraints. A number of community activities can take place such that the activities impact traffic. Thus, a route can be produces that lowers an influence the activities have upon a route. Moreover, a route can be produced that improves signal strength, such as strength of a signal used to communicate with a cellular telephone. In addition, a route can be enhanced by taking into account weather conditions, including real-time weather in addition to weather predictions.

### CROSS-REFERENCE

This application is a continuation-in-part of U.S. patent application Ser. No. 11/426,903 entitled “COLLABORATIVE ROUTE PLANNING FOR GENERATING PERSONALIZED AND CONTEXT-SENSITIVE ROUTING RECOMMENDATIONS” filed on Jun. 27, 2006, the entirety of which is herein incorporated by reference.

This application relates to U.S. patent application draft with Attorney Docket No. MSFTP2086US entitled “ROUTE MONETIZATION”.

This application relates to U.S. patent application draft with Attorney Docket No. MSFTP2087US entitled “FEDERATED ROUTE PRODUCTION”.

This application relates to U.S. patent application draft with Attorney Docket No. MSFTP2088US entitled “DESTINATION AUCTIONED THROUGH BUSINESS OF INTEREST”.

This application relates to U.S. patent application draft with Attorney Docket No. MSFTP2089US entitled “GENERATIONAL INTELLIGENT NAVIGATION SYNCHRONIZATION OR UPDATE”.

This application relates to U.S. patent application draft with Attorney Docket No. MSFTP2090US entitled “SOCIAL NETWORK BASED ROUTES”.

This application relates to U.S. patent application draft with Attorney Docket No. MSFTP2091US entitled “COGNITIVE CAR/RADIO”.

This application relates to U.S. patent application draft with Attorney Docket No. MSFTP2092US entitled “ADDITIONAL CONTENT BASED ON INTENDED TRAVEL DESTINATION”.

This application relates to U.S. patent application draft with Attorney Docket No. MSFTP2093US entitled “AUTOMATIC SPLICES FOR TARGETED ADVERTISEMENTS”.

This application relates to U.S. patent application draft with Attorney Docket No. MSFTP2094US entitled “PEDESTRIAN ROUTE PRODUCTION”.

### TECHNICAL FIELD

The subject specification relates generally to route production and in particular to optimizing a route for a user.

### BACKGROUND

Computer-driven automobile route planning applications are utilized to aid users in locating points of interest, such as particular buildings, addresses, and the like. Additionally, in several existent commercial applications, users can vary a zoom level, thereby enabling variation of context and detail as a zoom level of a map is altered. For example, as a user zooms in on a particular location, details such as names of local roads, identification and location of police and fire stations, identification and location of public services, such as libraries, museums, and the like can be provided to the user. When zooming out, the user can glean information from the map such as location of the point of interest within a municipality, state/providence, and/or country, proximity of the point of interest to major freeways, proximity of the point of interest to a specific city, and the like.

Furthermore, conventional computer-implemented mapping applications often include automotive route-planning applications that can be utilized to provide users with directions between different locations. Pursuant to an example, a user can provide an automotive route planning application with a beginning point of travel and an end point of travel (e.g., beginning and ending addresses). The route planning application can include or utilize representations of roads and intersections and one or more algorithms to output a suggested route of travel. These algorithms can output routes depending upon user-selected parameters. For instance, a commercial route planning application can include a check box that enables a user to specify that she wishes to avoid highways. Similarly, a user can inform the route planning application that she wishes to travel on a shortest route or a route that takes a least amount of time (as determined by underlying algorithms). Over the last several years, individuals have grown to rely increasingly on route planning applications to aid them in everything from locating a friend's house to planning cross-country road trips.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Conventional route generation devices optimize a route according to travel criteria. For instance, a user makes a request to a vehicle navigation system that a route takes a shortest amount of time. A search is performed upon available paths and a route is constructed based upon path metadata. Some advancement has taken place, such as optimizing a route such that a user does not have to take toll roads. However, conventional route production does not take into account extraneous circumstances that can influence a user.

The disclosed innovation allows a route to be improved (e.g., optimized) according to non-travel criteria. For example, a route can be improved according to community activities, signal strength, weather conditions, and the like. Activities that have a relatively high likelihood of affecting a route can be identified and the route can be modified to avoid user detriment from the activity. In addition, the route can be changed to optimize signal strength or to avoid areas known for poor signal strength. Moreover, weather conditions can be predicted and a route can be produced based upon the prediction.

Improvement of routes has focused on route-based criteria, such as finding a route that takes a shortest distance, or routes that are the fasted based upon posted speed limits, or routes that are least expensive from fuel consumption prospective. Little attention has been paid to improvement for routes that take into account user-based actions, such as driving history or a user being on a cellular telephone call. Practice of the disclosed innovation goes against industry direction such that focus is made upon route-external criteria.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative improved route production system in accordance with an aspect of the subject specification.

FIG. 2 illustrates a representative improved route production system with a detailed recognition component in accordance with an aspect of the subject specification.

FIG. 3 illustrates a representative improved route production system with a detailed fabrication component in accordance with an aspect of the subject specification.

FIG. 4 illustrates a representative improved route production system with a transaction component and disclosure component in accordance with an aspect of the subject specification.

FIG. 5 illustrates a representative improved route production methodology in accordance with an aspect of the subject specification.

FIG. 6 illustrates a representative notice obtainment methodology in accordance with an aspect of the subject specification.

FIG. 7 illustrates a representative manner determination methodology in accordance with an aspect of the subject specification.

FIG. 8 illustrates a representative route configuration in accordance with an aspect of the subject specification.

FIG. 9 illustrates an example of a schematic block diagram of a computing environment in accordance with the subject specification.

FIG. 10 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. It is to be appreciated that inferences or determination made in the subject specification can be practiced through implementation of artificial intelligence techniques.

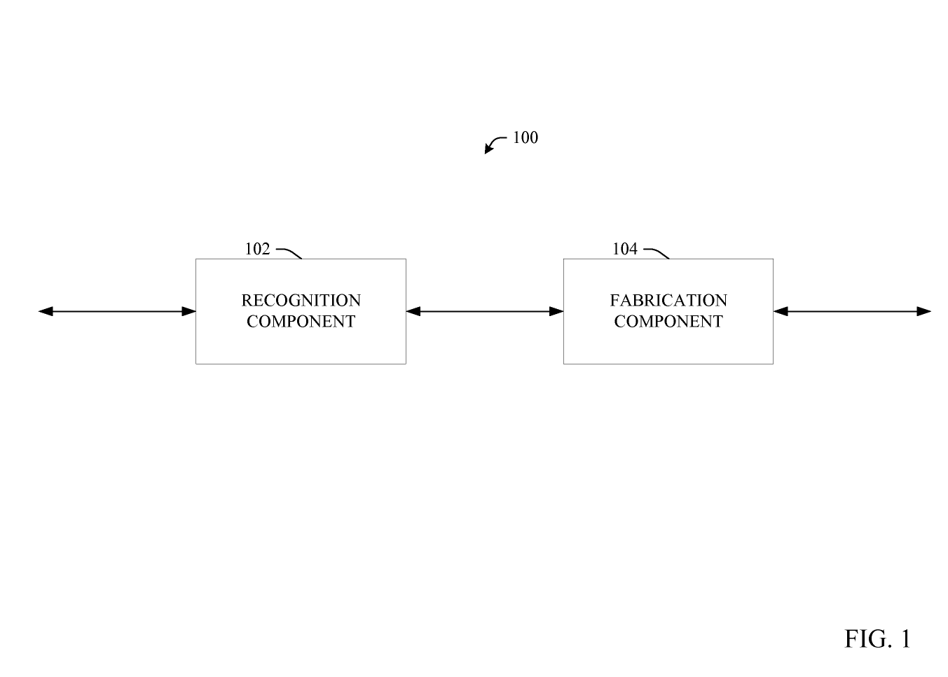

Now referring to FIG. 1, an example system 100 is disclosed for improving a route, commonly though route optimization. Conventional route generation systems optimize direction sets according to travel criteria. For instance, a user can request that directions between two different points take a user along a path that is estimated to be a shortest path. Various considerations are taken into account, such as road speed limits, road construction, and the like. Based upon the considerations, a route is produced that is estimated to be the shortest; however, the produced route can ultimately fail, such as an unexpected accident makes a route longer than anticipated during route production.

Route improvements (e.g., optimizations) of non-vehicle constraints can take place through practice of the subject specification. One major area of improvement allows general community activities to be taken into account. Depending on community activities (e.g., location, time, etc.), different routes can be produced that allow the user to achieve various goals.

A relatively large amount of information can be collected and processed by a recognition component 102. Based upon processing results, the recognition component 102 can identify at least one activity (e.g., a community based activity, an activity a user does not plan on partaking in, an activity with a likelihood of influencing traffic patterns, etc.) with a potential likely to affect the user. In addition to identifying activities, metadata concerning the activities can be ascertained or produced. For instance, identified activities can be weighted based upon estimated route impact. Example activities include public events (e.g., concerts, baseball games, graduations, etc.), social happenings (e.g., Christmas/Hanukkah/Kwanzaa related social phenomena, such as increased shopping, more individuals traveling, and so forth), and the like.

Information can transfer to a fabrication component 104 that enhances a route as a function of at least one identified activity. Common enhancements include a route that takes a shortest amount of time, a route that is estimated to be safest, a route that is anticipated to be most enjoyable (e.g., includes a scenic drive along a coastal road), and the like. Moreover, activities can be ordered such that a user completes the activities in a shortest amount of time.

The following is an example of an implementation of the system 100. For instance, a user can desire to take a route to purchase a new coat in a shortest amount of time where a downtown shopping area and suburban shopping area are available. A baseball game can take place in the downtown shopping area at a time the user intends to go shopping. Since the game can produce heavy traffic, noise, a greater amount of pedestrians, more shoppers, and the like, it can be advantageous for the user to plan around the baseball game activity. The recognition component 102 can identify the baseball game as an activity that can affect a route. The fabrication component 104 can produce a route (e.g., generate a route, alter a route, etc.) that is enhanced based upon the activity. According to one embodiment, the enhancement attempts to minimize impact of the baseball game; for instance, a route initially takes a user to the suburban shopping area such that if she finds an appropriate coat, she will avoid the activity all together. However, the fabrication component 104 can enhance the route by taking the user to the downtown shopping center during the game, thus avoiding time before or after the game where heavy traffic would be anticipated. It is to be appreciated that the disclosed innovation can produce an enhanced route according to more then one criteria (e.g., taking into account activities as well as weather conditions).

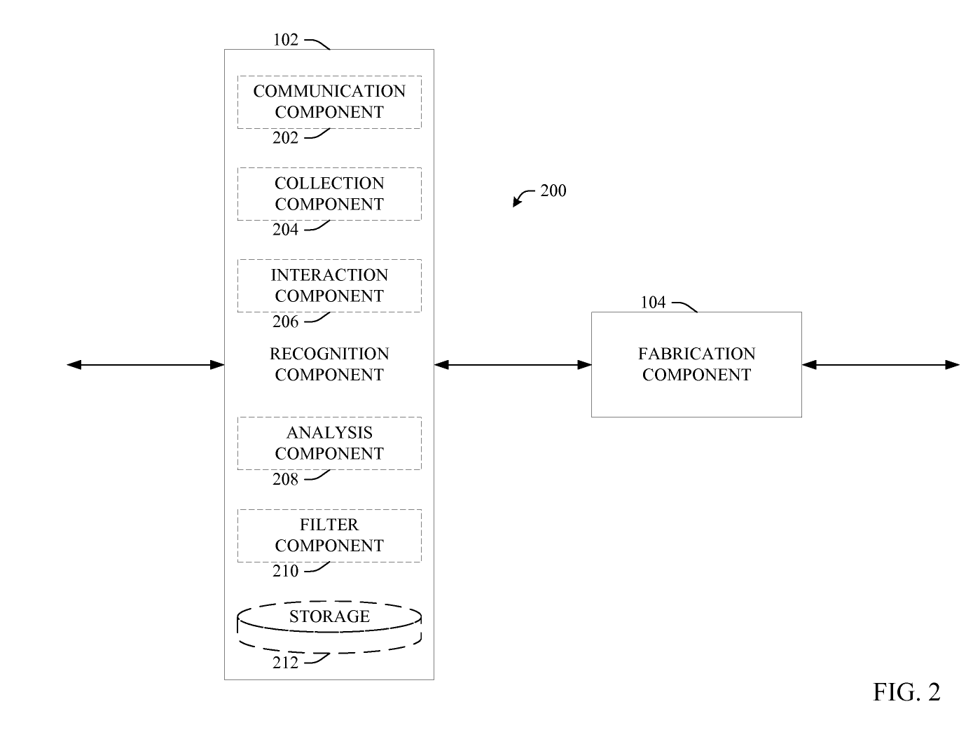

Now referring to FIG. 2, an example system 200 is disclosed for improving a route, commonly though route optimization with a detailed recognition component 102. A communication component 202 can engage with other devices to transfer information, such as to send a request for information, receiving information from an auxiliary source (e.g., a news organization that published details concerning events within a city), etc. Operation can take place wirelessly, in a hard-wired manner, employment of security technology (e.g., encryption, authentication, . . . ), etc. Moreover, the communication component 202 can utilize various protective features, such as performing a virus scan on collected data and blocking information that is positive for a virus. The communication can be active, (e.g., by submitting queries to an information source) or passive (e.g., by monitoring streaming information sources and selecting relevant parts).

A collection component 204 can obtain information related to activities, weather, signal strength, and so forth. Information locations can be searched and addresses of reliable sources can be retained locally. In addition, the collection component 204 can include verification capabilities. For instance, conflicting results from different sources can be resolved and an update can be made upon operation logic for the collection component 204.

An interaction component 206 allows a user to input constraints in which to operate, where a route is improved/optimized according to at least one provided constraint. For instance, a user can make a request inputted through the interaction component 206 for a route to be generated avoiding major activities or to pass by a major activity that is of interest to the user (e.g., a fishing exposition for an individual that enjoys outdoor activities). In another embodiment, the system 200 can automatically produce an improved route without user request. In addition, the user can directly input information that can be processed by the collection component 204. Various other enhancements can be made available, such as producing a route such that roads are avoided with a relatively high likelihood of accidents where the likelihood is derived from traffic statistics (e.g., a potential user accident can be considered an activity).

Obtained information (e.g., from the collection component 204, the interaction component 206, etc.) can be processed by an analysis component 208. The analysis component 208 can evaluate information, a result of the evaluation is used to identify at least one activity or enhance a route. Thus, the collection component 204 can obtain at least a portion of information used for evaluation. For instance, a sports team playing a game against a strong rival will commonly generate more traffic along a particular path near a stadium then a regular non-rivalry game. The fabrication component 104 can produce a route that avoids the particular path for an anticipated duration of the game, a calculated duration of the game, and so forth.

The recognition component 102 can gather a large amount of information and identify numerous activities. Processing the activities (e.g., processing by the fabrication component 104) can be a cumbersome task that consumes many resources of the system 200. Therefore, a filter component 210 can limit information that transfers to the fabrication component 104. For instance, it is likely that a major downtown opera performance is more significant than a child's birthday party hosted at a house along an obscure street. The filter component 210 can allows details concerning the opera performance to pass to a fabrication component 104 and block passage of details related to the birthday party. In addition, the filter component 210 can serve to block information that has security concerns. For instance, certain individuals can desire that personal events (e.g., a birthday party) not be disclosed to others. While the information can be blocked in different manners, (e.g., through an information provider, operation instructions of the communication component 202 that limit sources, and the like), according to one embodiment, the filter component 210 can stop private information from passing to the fabrication component 104 and block a user from appreciating the private information.

Different pieces of information, such as obtained information, component operating instructions (e.g., of the collection component 204), source location, an original route, etc. can be held on storage 212. Storage 212 can arrange in a number of different configurations, including as random access memory, battery-backed memory, hard disk, magnetic tape, etc. Various features can be implemented upon storage 212, such as compression and automatic back up (e.g., use of a Redundant Array of Independent Drives configuration).

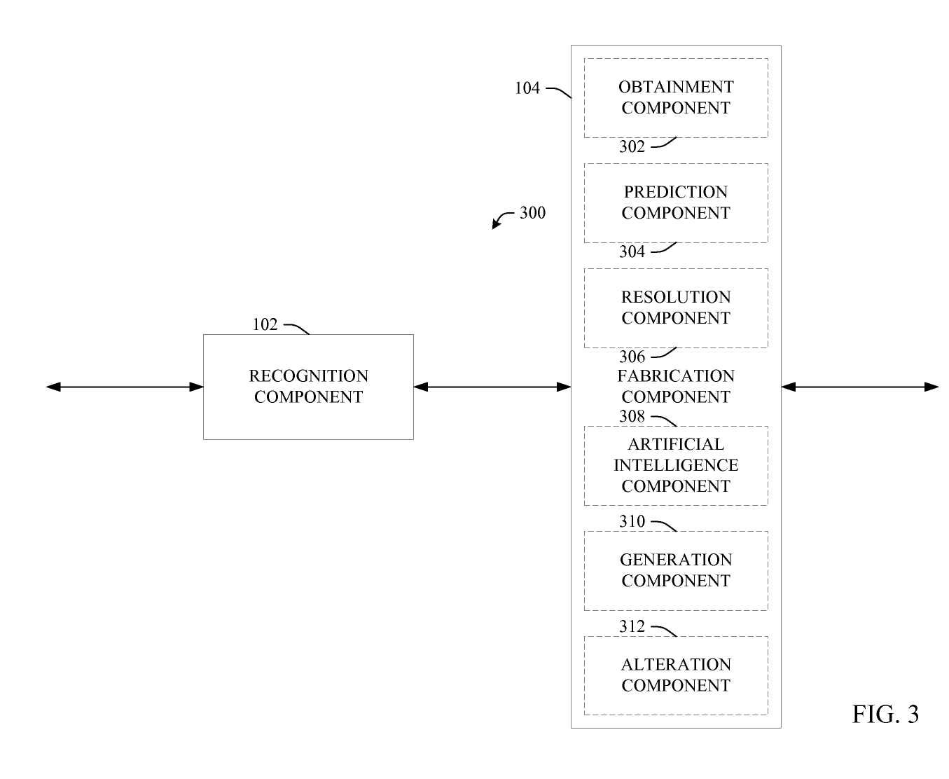

Now referring to FIG. 3, an example system 300 is disclosed for improving a route, commonly though route optimization with a detailed fabrication component 104. An obtainment component 302 can gather information, including output of the recognition component 102 as well as information from auxiliary sources, such as a map database. Operation can take place wirelessly, in a hard-wired manner, employment of security technology (e.g., encryption, authentication, . . . ), etc. Moreover, the obtainment component 302 can utilize various protective features, such as performing a virus scan on collected data and blocking information that is positive for a virus.

A prediction component 304 can make anticipations concerning route improvement. For instance, an activity that there is a worker's strike at a manufacturing plant can indicate that there will be slower traffic along a path where protestors are located. The prediction component 304 can anticipate that traffic along the route will be slower. Other predictions can be made concerning route, such as providing weather forecasts.

It is possible that multiple activities provide conflicting results and a resolution component 306 can solve related issues. For instance, a user can be partaking in an important conversation upon a cellular telephone. Different activities can impact signal strength such as repair to communication equipment (e.g., cellular telephone towers) or high volume in a particular area. Based upon these activities a route can be enhanced to improve signal strength of the cellular telephone (e.g., attempt to lower or minimize a likelihood of a signal becoming disconnected). The resolution component 306 can weigh the estimates and determine how the activity should be considered.

An artificial intelligence component 308 can make at least one inference or at least one determination in relation to the activity identification or the route enhancement. For example, the prediction component 304 can use the artificial intelligence component 308 to infer when an activity will take place (e.g., rush hour will occur at a particular time and thus there will be heavy traffic). In addition, the artificial intelligence component 308 can determine a time a user will take a route (e.g., a user is at work at 5 PM and it can be estimated she will travel to her home).

Artificial intelligence component 308 can employ one of numerous methodologies for learning from data and then drawing inferences and/or making determinations related to applying a service (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. Methods also include methods for the capture of logical relationships such as theorem provers or more heuristic rule-based expert systems.

According to one embodiment, there is not a current route and thus the fabrication component 104 can produce a new route. A generation component 310 can access a mapping database and determine routes that should be combined to create a direction set. Various features can integrate with the generation component 310 to enhance functionality; for example, the generation component 310 can predict an intended destination of a user and create a route to the predicted intended destination.

However, it is possible a route already exists (e.g., from the generation component 310 or from an auxiliary location) and the existing route is to be enhanced. An alteration component 312 can improve a route by modifying at least a portion of a route. In an example illustration, the alteration component 312 can verify safety characteristics of the identified portion, determine a replacement portion that is safer, and modify the route to use the replacement portion as opposed to the identified portion. Thus, with the generation component 310 and alteration component 312, the fabrication component 104 can generate the enhanced route or alter a route in existence to enhance the route in existence

According to one embodiment, the system 300 optimizes a route in relation to weather conditions. The recognition component 102 can gather a message that directions should be enhanced for weather conditions. In an illustrative instance, a person can be driving an automobile with a poor history of performance in snow, where the history is gathered from multiple automobiles through utilization of a central server. A message can be received that snow is anticipated and a route should be generated that limits hills or sharp curves. The notice can originate automatically from an auxiliary location (e.g., local source, remote source, removable source, etc.) and be gathered by the collection component 204 of FIG. 2, be inputted by a user through the interaction component 206 of FIG. 2, etc. The notice can be evaluated by the analysis component 208 of FIG. 2 such that there is operation as a means for evaluating a notice to enhance a direction set according to weather. Based at least in part on the evaluation, a manner in which to enhance a direction set (e.g., select particular roads, provide specific details with a route, suggestion actions such as driving speed, etc.) can be determined by the resolution component 306. Thus, the resolution component 306 can implement as a means for determining a manner in which to enhance the direction set according to weather based at least in part off a result of the evaluation.

The system 300 can have additional functionality concerning route enhancement through weather condition analysis. The prediction component 304 can anticipate weather conditions (e.g., analyzing weather patterns of nearby areas, performing calculations on readings such as barometric pressure, using historical data, and the like). Thus, the prediction component 304 can function as a means for predicting at least one weather condition. Moreover, the analysis component 208 of FIG. 2 can implement as a means for evaluating a weather condition that can originate from a weather database. For instance, a message can be collected that it is raining at a current location and there is rain along a suggested road. Through use of the generation component 310 or alteration component 312 a route can be produced or altered in view of predicted or actual weather conditions. Therefore, the generation component 310 can operate as a means for generating a route according to the determined manner in which to enhance the direction set based upon at least one predicted weather condition or at least one evaluated weather condition. In addition, the alteration component 312 can configure as a means for altering an existing direction set according to the determined manner in which to enhance the direction set based upon at least one predicted weather condition or at least one evaluated weather condition.

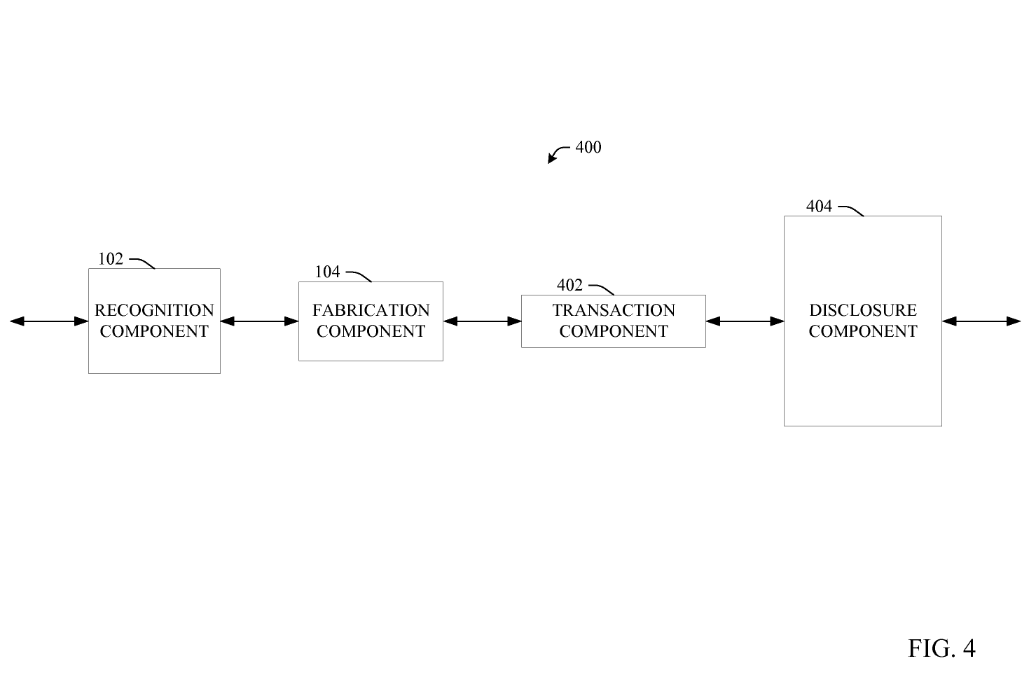

Now referring to FIG. 4, an example system 400 is disclosed for improving a route, commonly though route optimization with a transaction component 402 and a disclosure component 404. A recognition component 102 can identify at least one activity with a potential to affect a user. A fabrication component 104 can enhance a route as a function of at least one identified activity. According to an alternative embodiment, the recognition component 102 can identify at least one user activity and the fabrication component 104 can produce a route that improves (e.g., optimizes) a route in order to accomplish at least one identified activity. For instance, if a user is to stop for fuel and ice cream, the ice cream stop can be second since it can be inferred a user desires for the ice cream to be in a vehicle for a short (e.g., shortest) amount of time.

A party can request payment for services rendered or to be completed, such as providing information, posting data, generating or altering a route, etc. The transaction component 402 can perform a reward (e.g., financial, non-financial, etc.) operation in relation to the activity identification or the route enhancement. The transaction component 402 can perform actions to meet constraints, such as debiting a user account and crediting a provider account. While fiscal amounts are commonly transacted, it is to be appreciated that other commodities can be exchanged, such as coupons, meeting of contractual obligations (e.g., canceling of a task to be performed), tax credits, etc.

The transaction component 402 can function with an advertisement component that augments a route with a commercial detail (e.g., advertisement for a user to purchase a produce, coupon, etc.). In addition, the reward operation can take place in relation to user response to a commercial detail. For example, an advertisement can be played that a user should stop at a highway vehicle for a cup of coffee. If the user takes the exit, buys the cup of coffee, buys a different item, etc., then varying amounts of information can be paid to an advertisement hosting service.

A disclosure component 404 can provide the route to a user (e.g., vehicle operator, passenger, pedestrian, etc.). A non-exhaustive list of disclosure components include a display screen, touch screen, speaker system, virtual reality environment, Braille production system, printer, etc. In addition, the disclosure component 404 can present information in multiple formats, such as showing a video with audio capabilities. Moreover, the disclosure component 404, as well as other components disclosed in the subject specification can implement upon a personal electronic device (e.g., cellular telephone, personal digital assistant, etc.), upon a vehicle (e.g., automobile, motorcycle, bicycle, airplane, helicopter, motorboat, self-balancing transportation device, etc.), etc.

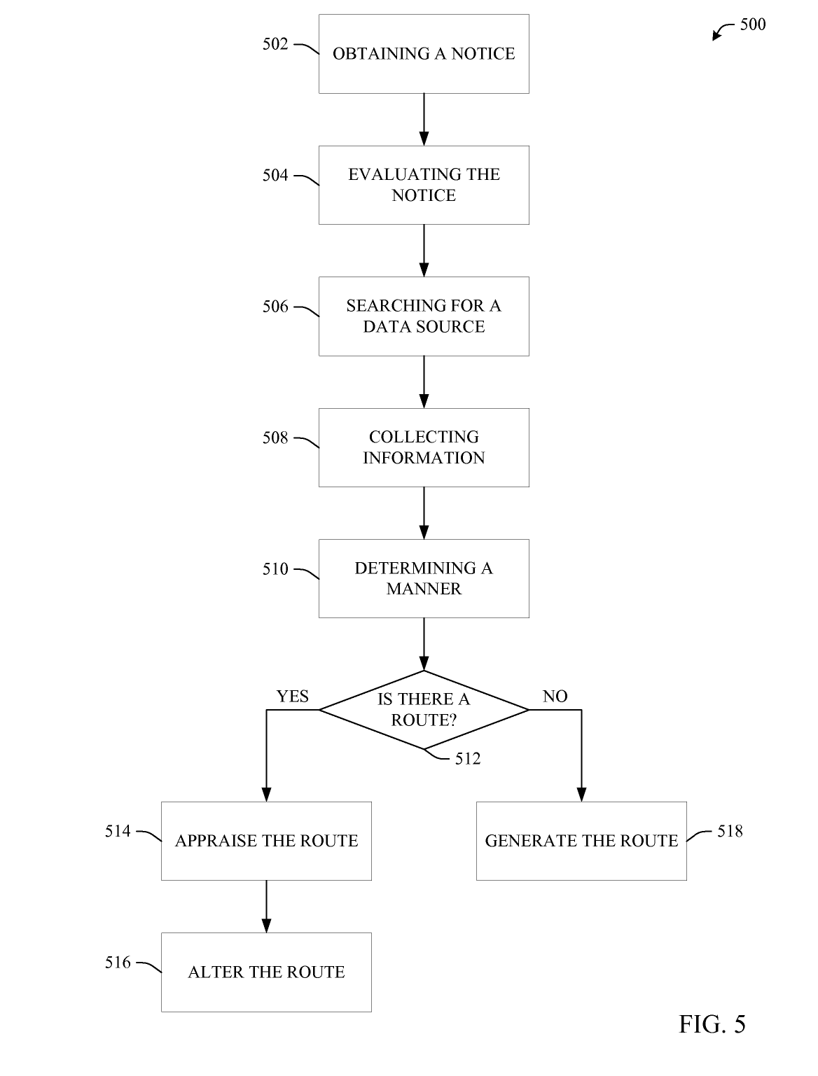

Now referring to FIG. 5, an example methodology 500 is disclosed for enhancing a route, specifically in relation to signal strength (e.g., oftentimes communication signal strength, such as between a cellular telephone and a tower), although other enhancements can be practiced with events, action, acts, and the like of the methodology 500 (and related methodologies disclosing implementation of events). The methodology 600 allows for improvement of travel concerning radio signals (e.g., electromagnetic waves). A notice that an improved route is to be enhanced is collected at event 502; the notice can originate automatically, from a user, etc.

A notice can be evaluated in order to assist in determining how a route should be improved at action 504. For instance, a notice can make a specific request, such as a user asking for a route to allow a signal to be a strong as possible. However, the notice can be vague—a user can make a request for a quality signal. However, the user can desire for the strength to on average to be as high as possible or care little about signal average, so long as a certain threshold is met. Action 504 can be used to resolve ambiguity related to a request.

Block 506 discloses searching for a data source that can provide relevant data for route enhancement. A vast amount of sources can be used to produce information and block 506 can filter through the sources. For instance, sources can be identified as having a high, medium, or low likelihood of producing data relevant to signal strength.

Information can be collected from a discovered data source at act 508. Information can be extracted for the source, copied for the source and retained locally, and the like. Various protections can be implemented, such as determining if information originates from a reliable source. Moreover, updates can take place to operation instruction of the methodology 500—in one illustrative instance, a source that produced verifiable information can be considered a ‘reliable source’.

A determination of a manner in which to enhance a direction set can take place at event 510. Example manners can include modifying a route, generating a new route, adding information to a route that assists the user, and the like. Moreover, the determination of the manner can be specific, such as what streets should be included, how a route should be modified, areas to avoid, having a user travel through an area at a specific time, suggest speeds for specific weather conditions, etc. It is to be appreciated that event 502 and event 510 operate in sequence (e.g., follow one another).

A check 512 can determine if a route already exists that is to be modified. If a route does exist, then the route can be appraised at action 514. Route appraisal results can be used to determine a specific approach in which to improve a route (e.g., if ‘Vine Street’ has poor reception, then take ‘Market Street’ as opposed to ‘Vine Street’). Based upon the results, the appraisal result, the route can be altered at action 516. If the check 512 discloses that a route does not exist, a new route can be generated through block 518.

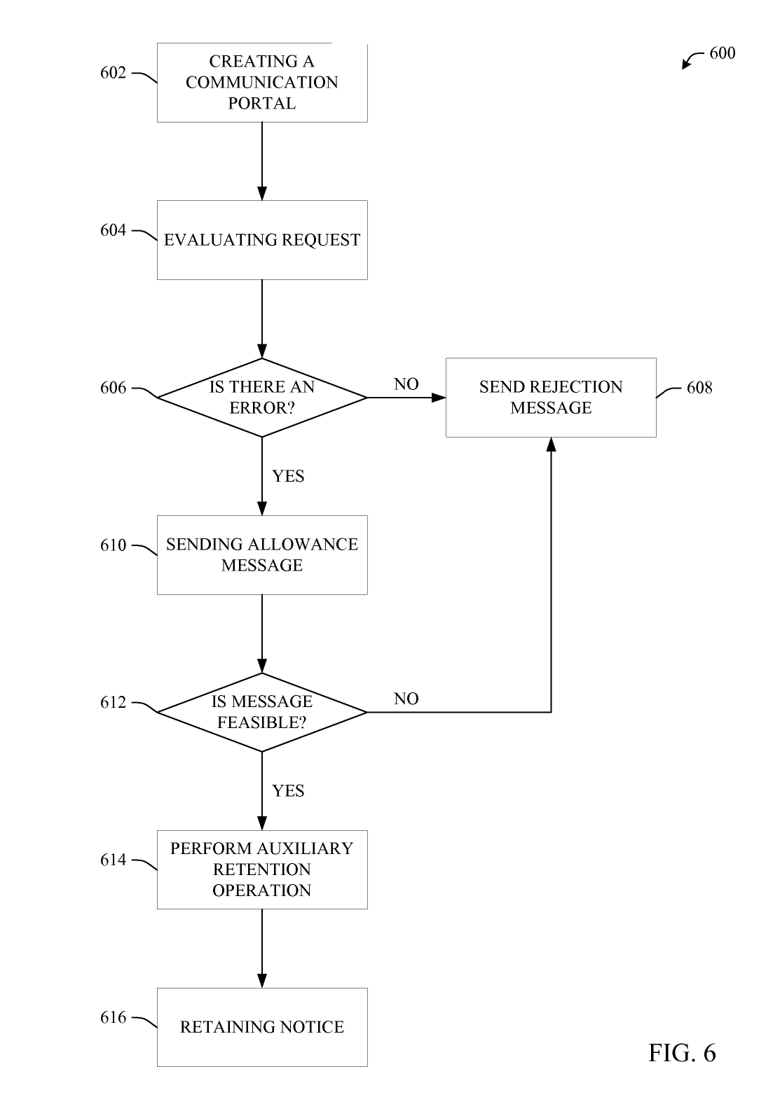

Now referring to FIG. 6, an example methodology 600 is disclosed for obtaining a notice to enhance a direction set according to a signal, such that can be practiced in event 502 of FIG. 5. A communication portal can be created at action 602; for instance, the portal can allow a user to provide a notice, for a notice to be provided by an advertisement host, etc.

A request can be analyzed at action 604 to make various determinations or inferences. For instance, a request can be for a foreign requestor attempting to alter a route illegally to take a user past an advertisement—a request such as this can be considered a form of ‘spam’ and ultimately be denied. Moreover, request analysis can determine parameters by which a route should be modified (e.g., to improve signal strength).

A check 606 can take place to discover if a request includes an error; for example, a request can be made by a user to alter a route based upon a baseball game on June 1. However, if there is no game on June 1, then a rejection message can be set at act 608. Other embodiments can be practiced by the methodology 600, such as inferring if the user has made an error and determining the baseball game is on July 1 when the request is made on July 1. If a request does not include an error or does not include a substantial error (e.g., initially, after modification from a drawn inference, etc.), then an allowance message can be sent at event 610.

A check 612 can occur to determine if an allowance message is feasible. In an illustrative instance, a user can request to avoid rain; however, if all paths between a starting point and an intended destination are subjected to rain, then the methodology 600 can return to act 608 and instruct a user that a route cannot be enhanced. According to one embodiment, an enhancement can take place that minimizes rain even when a user requests to avoid rain. A retention action can take place at action 614 such as clearing enough storage that the notice as well as evaluation results can be retained locally. In addition, operations can be performed upon the notice or evaluation results, such as compressing the information to save storage space or encrypting the information. The notice as well as the evaluation results can be retained in storage through action 616.

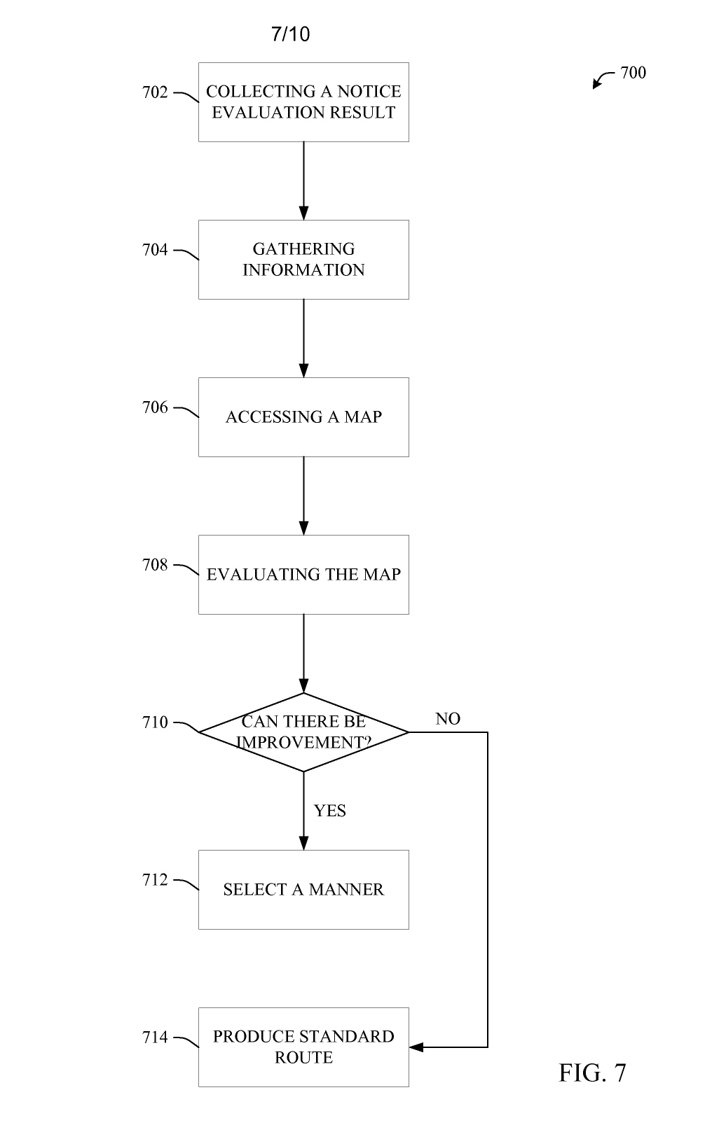

Now referring to FIG. 7, an example methodology 700 is disclosed for determining a manner in which to enhance the direction set according to the signal, such that can be practiced in event 510. Notice evaluation results can be collected at event 702, such as from storage that had the information retained at action 614 of FIG. 6; additionally, a notice itself can be collected.

Information relevant to manner determination can be gathered at action 704. In addition to gathering information, a map can be accessed (e.g., a map that is included in information gathered at action 704) though event 706. For instance, multiple maps can be downloaded from different sources and combined together to create a singular map (e.g., through resolving inaccuracies, such as roads with different names) and an accessed map can be evaluated at event 708.

A verification 710 can take place to determine if a route improvement can be made. If an improvement can be made, then an appropriate manner is selected 712 (e.g., a best manner) through analysis of information gathered at action 704. For example, a route can be improved by altering paths along the route or by changing order of waypoints. However, a route can configure in a manner that does not allow the route to be improved. For example, it is possible that a route is already optimized or that an improvement cannot be determined (e.g., anticipated signal strength cannot be ascertained). Therefore, a standard route can be produced through action 714.

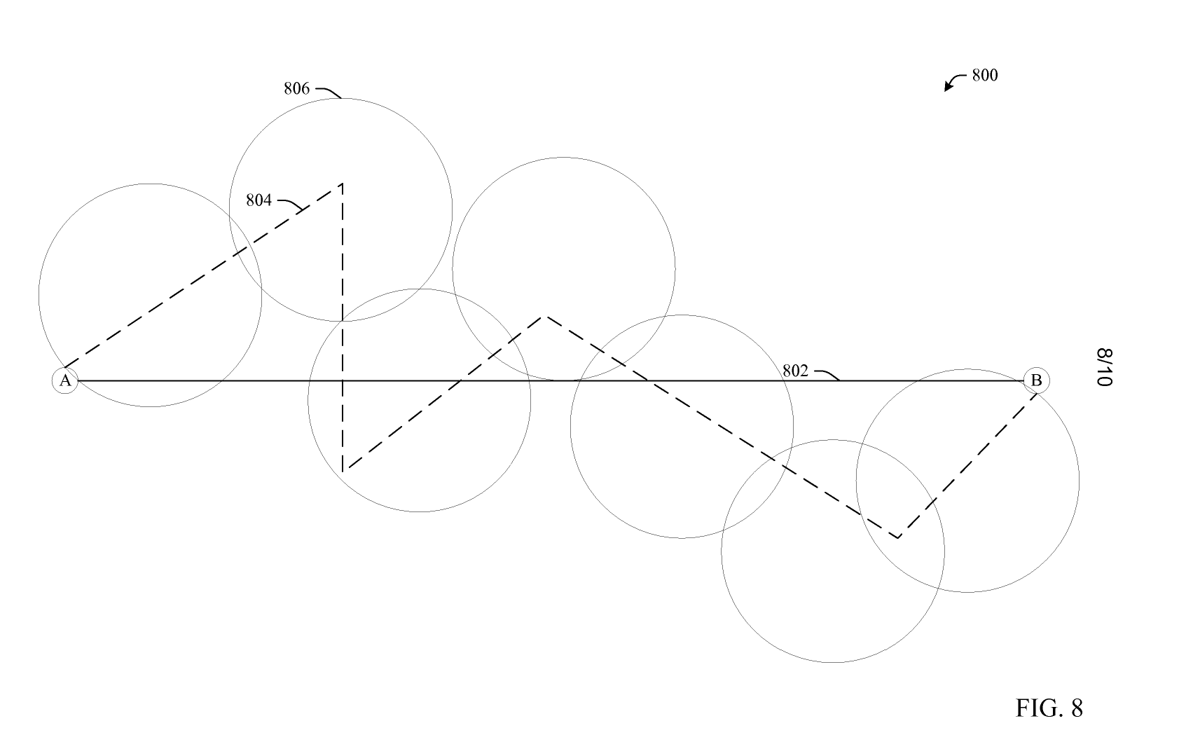

Now referring to FIG. 8, an example route enhancement implementation 800 is disclosed for practicing of aspects of the subject specification. According to one embodiment, the implementation 800 can be presented upon the disclosure component 404 of FIG. 4. A user can make a request that a route be generated from a starting point A to an intended destination B.

Using conventional method, a standard route 802 can be generated under an assumption that a user desires for a route to be produced that is shortest in distance. The conventional route can take the user along a straight path between the staring point A and the intended destination B. Other assumptions can be made, such as that a user desires to take a fastest route.

However, a situation can arise that a user wants to improve a route according to a signal, such as a cellular telephone signal. Determination of the situation can take place through a variety of different manners. A user can make a direct request of a route to be produced that takes signal strength into account. In another manner, a system producing an enhanced route (e.g., the system 100 of FIG. 1) can perform complex analysis. For instance, a user can receive an important incoming phone call upon a cellular telephone while operating a vehicle. Analysis of a caller can be made (e.g., through evaluation of a contact list, comparison of a time called with a calendar, such as identifying the call relates to a meeting, etc.) and based on analysis results, it can be determined an enhanced route should be produced. It is to be appreciated that an enhanced route can be produced while a user is already in transit, including adding a waypoint or modifying a destination (e.g., changing a suggested shopping center).

An analysis of a cellular infrastructure can produce areas where there is a relatively low likelihood that a user will have a call disconnected. Information that can be used in analysis can include data published by a cellular provider, infrastructure or telephone history, usage traffic (e.g., current, predicted), and the like. Based upon the information collected, a determination can be made on how to construct an improved route 804.

According to one embodiment, route construction can take place through rule implementation. In an illustrative instance, a rule can be used that if a route is to be improved concerning signal strength and a path includes a tunnel, then the path with the tunnel will be automatically avoided if reasonably possible. The improved route 804 can attempt to take a user through areas 806 with a relatively high likelihood of reliability of signal strength. While an improved route 804 is disclosed that takes a user completed through areas 806, it is to be appreciated that the improved route 806 can be a non-perfect enhancement.

While aspects of the subject specification discuss optimization of a route towards activities, signal strength, and weather, it is to be appreciated the aspects can be practiced towards any type of route improvement (e.g., optimization). For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

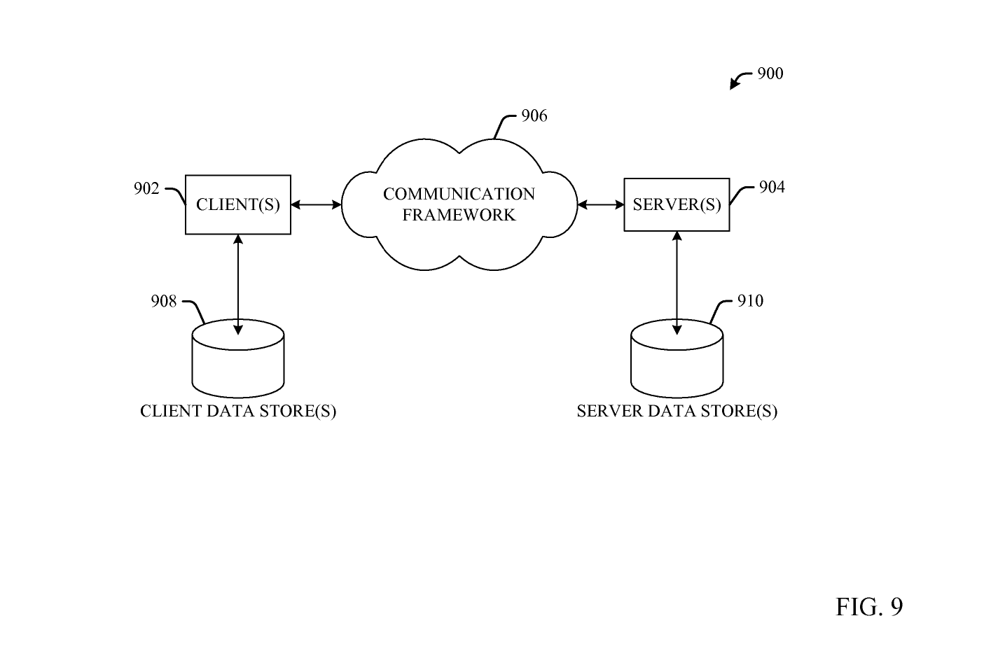

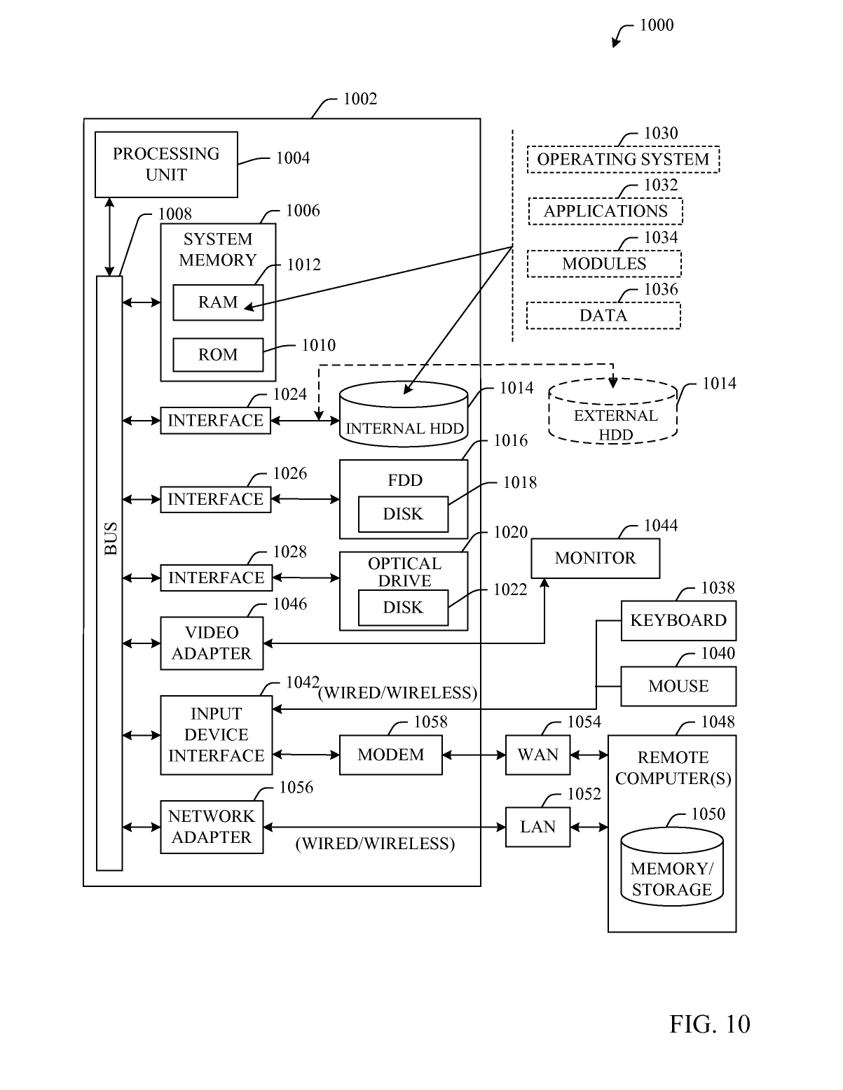

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The aforementioned systems have been described with respect to interaction among several components. It should be appreciated that such systems and components can include those components or sub-components specified therein, some of the specified components or sub-components, and/or additional components. Sub-components can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a recognition component that identifies at least one activity with a potential to affect a user; and
a fabrication component that enhances a route as a function of at least one identified activity.

2. The system of claim 1, further comprising an analysis component that evaluates information, a result of the evaluation is used to identify at least one activity or enhance a route.

3. The system of claim 2, further comprising a collection component that obtains at least a portion of information used for evaluation.

4. The system of claim 1, further comprising a disclosure component that presents the enhanced route to the user.

5. The system of claim 1, further comprising a transaction component that performs a reward operation in relation to the activity identification or the route enhancement.

6. The system of claim 1, further comprising an interaction component that obtains a request from a user for enhancement of the route.

7. The system of claim 1, the fabrication component generates the enhanced route.

8. The system of claim 1, the fabrication component alters a route in existence to enhance the route.

9. The system of claim 1, further comprising an artificial intelligence component that makes at least one inference or at least one determination in relation to the activity identification or the route enhancement.

10. A method, comprising:
obtaining a notice to enhance a direction set according to a radio signal; and
determining a manner in which to enhance the direction set according to the radio signal.

11. The method of claim 10, evaluating the notice to enhance the direction set, a result of the notice evaluation is used in determining the manner in which to enhance the direction set.

12. The method of claim 11, collecting information based upon the notice, determining the manner is based at least in part off collected information.

13. The method of claim 12, further comprising searching for at least one data source, information is collected from at least one data source discovered through searching.

14. The method of claim 10, further comprising generating a route according to the determined manner in which to enhance the direction set.

15. The method of claim 10, further comprising altering an existing direction set according to the determined manner in which to enhance the direction set.

16. The method of claim 15, further comprising appraising the existing direction set, the appraisal result is used in altering the existing direction set.

17. A system, comprising,
means for evaluating a notice to enhance a direction set according to weather; and
means for determining a manner in which to enhance the direction set according to weather based at least in part off a result of the evaluation.

18. The system of claim 17, further comprising means for predicting at least one weather condition or means for evaluating a weather condition.

19. The system of claim 18, further comprising means for altering an existing direction set according to the determined manner in which to enhance the direction set based upon at least one predicted weather condition or at least one evaluated weather condition.

20. The system of claim 18, further comprising means for generating a route according to the determined manner in which to enhance the direction set based upon at least one predicted weather condition or at least one evaluated weather condition.
